(19) United States
(12) Patent Application Publication
(10) Pub. No.: US 2014/0105224 A1
(43) Pub. Date: Apr. 17, 2014

(54) Retransmissions in a Communication System Using Almost Blank Subframes

(71) Applicants: Frank Frederiksen, Klarup (DK); Klaus Ingemann Pedersen, Aalborg (DK); Stanislaw Strzyz, Poznan (PL)

(72) Inventors: Frank Frederiksen, Klarup (DK); Klaus Ingemann Pedersen, Aalborg (DK); Stanislaw Strzyz, Poznan (PL)

(73) Assignee: Nokia Solutions and Networks Qy, Espoo (FI)

(21) Appl. No.: 14/124,773

(22) PCT Filed: Jun. 9, 2011
(86) PCT No.: PCT/EP2011/059631

§ 371 Date: Dec. 9, 2013

(51) Int. Cl. H04L 1/18; H04L 5/00; H04L 29/06

(52) U.S. Cl. CPC H04L 1/1854; H04L 69/22; H04L 5/0032
USPC 370/465

(57) ABSTRACT

A method and apparatus for controlling retransmissions of subframes is disclosed. In the method the type of a received subframe is determined. Identification of the subframe for retransmission purposes is then controlled based on the determined type of the subframe. A node receiving a request for retransmission of the subframe provided with an identification based on the type of the subframe determines based on the identification for retransmission purposes the subframe for which retransmission is requested.

This disclosure relates to retransmissions in a communication system.

A communication system can be seen as a facility that enables communication sessions between two or more entities such as fixed or mobile communication devices, base stations, servers and/or other communication nodes. A communication system and compatible communicating entities typically operate in accordance with a given standard or specification which sets out what the various entities associated with the system are permitted to do and how that should be achieved. For example, the standards, specifications and related protocols can define the manner how various aspects of communication shall be implemented between communicating devices. A communication can be carried on wired or wireless carriers. In a wireless communication system at least a part of communications between stations occurs over a wireless link.

Examples of wireless systems include public land mobile networks (PLMN) such as cellular networks, satellite based communication systems and different wireless local networks, for example wireless local area networks (WLAN). A wireless system can be divided into cells or other radio coverage or service areas. A radio service area is provided by a station. Radio service areas can overlap, and thus a communication device in an area can typically send signals to and receive signals from more than one station.

A user can access the communication system by means of an appropriate communication device. A communication device of a user is often referred to as user equipment (UE) or terminal. A communication device is provided with an appropriate signal receiving and transmitting arrangement for enabling communications with other parties. Typically a communication device is used for enabling receiving and transmission of communications such as speech and data. In wireless systems a communication device provides a transceiver station that can communicate with another communication node such as e.g. a base station and/or another user equipment.

An example of communication systems is an architecture that is being standardized by the 3rd Generation Partnership Project (3GPP). This system is often referred to as the long-term evolution (LTE) of the Universal Mobile Telecommunications System (UMTS) radio-access technology. A further development of the LTE is often referred to as LTE-Advanced. The various development stages of the 3GPP LTE specifications are referred to as releases.

A communication system can be provided with error correction functionality, such as with a possibility of requesting for retransmission of any information that the recipient could not successfully decode. For example, the 3GPP LTE uses a hybrid automatic repeat request (HARQ) error control mechanism. The error control mechanism can be implemented such that a device which receives either a positive or a negative acknowledgement (ACK/NACK) or other indication from another device of an error free or erroneous receipt of transmitted data can take appropriate action. Typically this means resending of a protocol data unit to the receiving device in response to a negative acknowledgement. In LTE the acknowledgement signalling can be communicated on a physical HARQ indicator channel (PHICH) based on a HARQ timing scheme.

A communication system can comprise different types of radio service areas providing transmission/reception points for the users. For example, in LTE-Advanced the transmission/reception points can comprise wide area network nodes such as a macro eNode B (eNB) which may, for example, provide coverage for an entire cell or similar radio service area. Network nodes can also be small or local radio service area network nodes, for example Home eNBs (HeNB), pico eNodeBs (pico-eNB), or femto nodes. Some applications utilise radio remote heads (RRH) that are connected to for example an eNB. The smaller radio service areas can be located wholly or partially within the larger radio service area. A user equipment (UE) may thus be located within, and communicate with, more than one radio service area. The service areas may also be of different type. This may cause interference.

The 3GPP Release 10 specifications introduced a concept called time domain (TDM) enhanced inter-cell interference coordination (eICIC). The eICIC concept provides coordination mechanisms for enabling reduction in downlink interference caused by an aggressor cell to a victim cell. However, it can have some undesirable effects on uplink performance. Two exemplifying cases can be mentioned to illustrate this. In Pico-Macro case the coverage area of pico cell is extended by a mechanism where the macro cell mutes given subframes in the time domain, thereby causing a reduction of interference seen by user equipments connected to the pico node. This may be especially the case for user equipments that are close to the edge of a pico coverage area. This may also be the case when a pico node is using a range extension such that pico connected user equipments are kept in connected mode towards the pico node, even if the macro downlink (DL) connection may have better conditions. Typical reasons for extending the coverage area of the pico node are better uplink link budget and potentially also offloading of the macro node. In Macro-Femto case an aggressor cell can be for example a closed subscriber group (CSG) Home eNB. The HeNB can apply some time domain muting patterns to give user equipments within the coverage area of the CSG HeNB the chance of “hearing” the macro cell. In this way, all macro connected user equipments can potentially be connected to the macro node and avoid experiencing a coverage hole.

The downlink TDM muting patterns can be indicated to user equipments through dedicated signaling proving information on which subframes in the time domain are to be used for which purpose. One possibility for muting patterns is to indicate almost blank subframes (ABS). In these an aggressor only transmits limited information such as information vital to the operation of the system. Examples of these include reference symbols, synchronization sequences, broadcast channels, and so on. No other physical downlink control channel (PDSCH) will be transmitted with the current proposals. A bit map pattern is used to indicate the ABS pattern which is exchanged between the macro eNB and pico eNB through an X2 message. Thus under the current eICIC schemes, the macro eNodeB applies almost blank sub-frames according to a predefined pattern, the ABS pattern, to guarantee the pico cell edge user equipment performance. The concept of almost blank subframe (ABS) and what is transmitted during these is described in more detail for example in 3GPP TR 36.300, Version 10.3.0 of March 2011.

A result of use of downlink time domain (TDM) muting patterns is that only essential information is conveyed from an aggressor cell during the ABS. This can mean that the aggressor cell is not allowed to transmit any information that is related to the downlink direction. Considering from downlink scheduling point of view this is a sensible configuration, as the downlink data channel (physical downlink shared channel; PDSCH) is transmitted within the same transmit time interval (TTI) as the downlink control channel (physical downlink control channel; PDCCH). However, as uplink data may also need scheduling through the PDCCH there will be a loss of uplink capacity when applying TDM eICIC. In here it shall be appreciated that scheduling decisions, including scheduling decisions for the uplink direction are taken by the base station. Additionally, there is a fixed timing relationship between the PDCCH transmitted in the downlink and the uplink transmission on the physical uplink shared channel (PUSCH) of 4 subframes. This is arranged such that a PDCCH grant for UL data in subframe ‘k’ will result in physical uplink shared channel (PUSCH) transmission in subframe ‘k+4’ for Frequency Division Duplex (FDD) configuration. The timing is different for Time Division Duplex (TDD) configuration.

Release 8 of LTE defines that HARQ for uplink shall be based on synchronous operation. A benefit from this is reduced signalling as well as fixed and known timing relations between transmissions and potential retransmissions. Because of this a user equipment does not need to stay awake looking for retransmission requests/grants at random times, but can tie these to fixed time instants. Further, in accordance with LTE Release 8 FDD shall operate with 8 ms HARQ round trip time (RTT). As the transmission time interval (TTI) is 1 ms, a total of 8 HARQ processes are available to facilitate continuous uplink transmission from a single user equipment.

A drawback of synchronous uplink hybrid automatic repeat request (UL HARQ) is that if a retransmission grant is missed by the user equipment, the next scheduling opportunity will be located an additional delay later corresponding to the RTT. In the LTE based systems that would be 8 ms. If UL HARQ is combined with ABS, retransmission delays can be impacted heavily by the introduction of ABS patterns at the macro and femto nodes in the system. This may be the case especially when extensive muting is applied, and there may be problems with high retransmission delays for uplink data.

It is noted that the above discussed issues are not limited to any particular communication environment, but may occur in any appropriate communication system with retransmission mechanism.

Embodiments of the invention aim to address one or several of the above issues.

In accordance with an embodiment there is provided a method of controlling retransmission of subframes, comprising determining the type of a subframe, and controlling identification of the subframe for retransmission purposes based on the determined type of the subframe.

In accordance with another embodiment, there is provided a method of controlling retransmission of subframes, comprising receiving a request for retransmission of a subframe, wherein the requested subframe is provided with an identification for retransmission purposes by a receiving station based on the type of the subframe, the identification for retransmission purposes being different from the identification used when previously transmitting the subframe, and determining based on the identification for retransmission purposes which one of the previously transmitted subframes is requested.

In accordance with an embodiment, there is provided an apparatus for controlling retransmissions, the apparatus comprising at least one processor, and at least one memory including computer program code, wherein the at least one memory and the computer program code are configured, with the at least one processor, to determine the type of a subframe, and to control identification of the subframe for retransmission purposes based on the determined type of the subframe.

In accordance with an embodiment, there is provided an apparatus for controlling retransmission of subframes from a transmitting node, the apparatus comprising at least one processor, and at least one memory including computer program code, wherein the at least one memory and the computer program code are configured, with the at least one processor, to process a request for retransmission of a subframe to determine the subframe that is requested based on an identification for retransmission purposes, wherein the identification for retransmission purposes is provided by a receiving node based on the type of the subframe and is different from an identification used when the subframe was previously transmitted by the transmitting node.

In accordance with a more specific embodiment, the subframes for retransmissions are numbered such that subframes of at least a type are ignored when counting the subframes.

In some embodiment it is determined whether the subframe is a muted subframe. The determining may comprise determining whether the subframe is an almost blank subframe.

The subframes can be sequentially numbered for retransmissions such that muted subframes are ignored and retransmission identifiers are assigned only for non-muted subframes. Sequential HARQ process identities can be assigned only for non-muted subframes.

Information of muting of subframes may be communicated to a user equipment. Information about an almost blank subframe pattern of a cell may be communicated to a user equipment in the cell.

Muted subframes may be determined based on channel state information measurement pattern and almost blank subframe pattern.

The number of retransmission processes may also be determined. The number of retransmission processes can be to be less than is the number of available total of retransmission processes.

Muting patterns can be applied to communications for the purposes of time domain enhanced inter-cell interference coordination.

A computer program comprising program code means adapted to perform the method may also be provided.

Various other aspects and further embodiments are also described in the following detailed description and in the attached claims.

The invention will now be described in further detail, by way of example only, with reference to the following examples and accompanying drawings, in which:

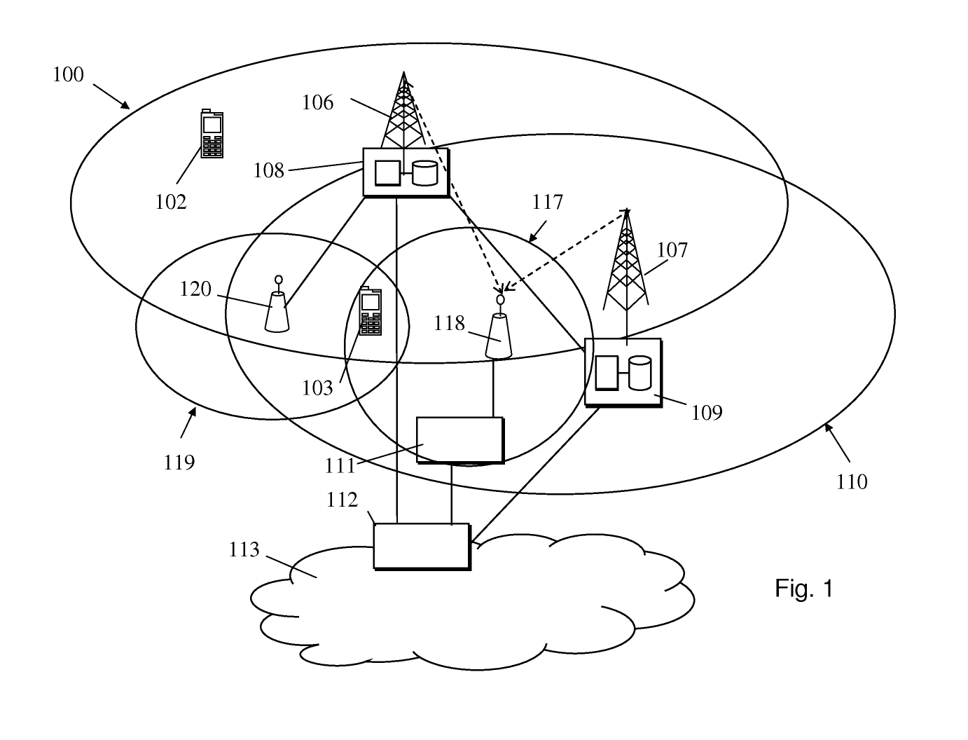

FIG. 1 shows a schematic diagram of a network according to some embodiments;

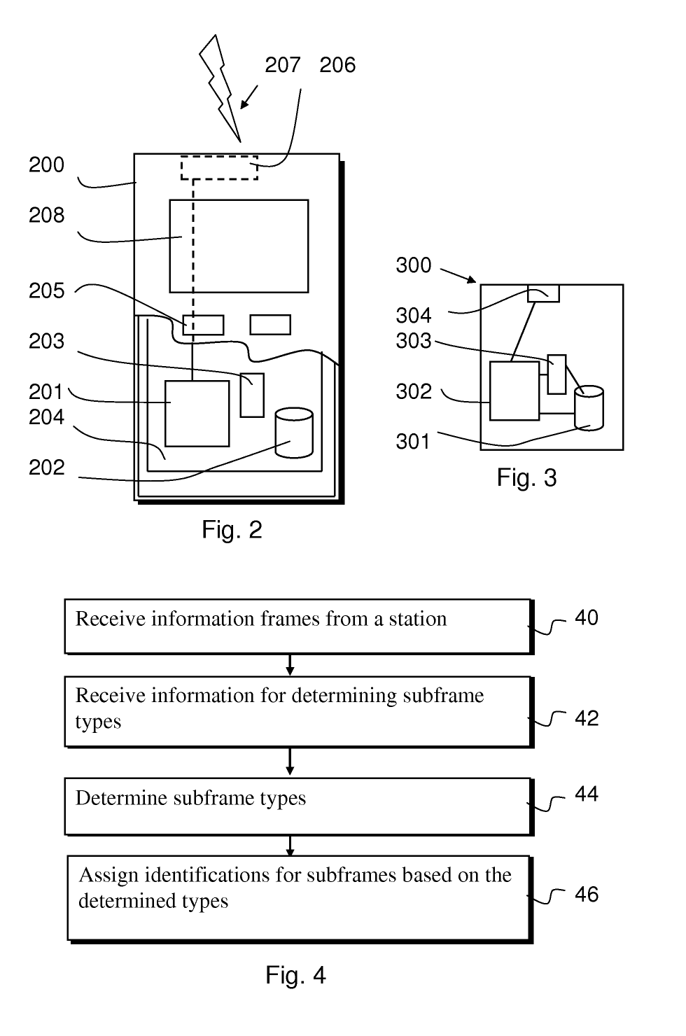

FIG. 2 shows a schematic diagram of a mobile communication device according to some embodiments;

FIG. 3 shows a schematic diagram of a control apparatus according to some embodiments;

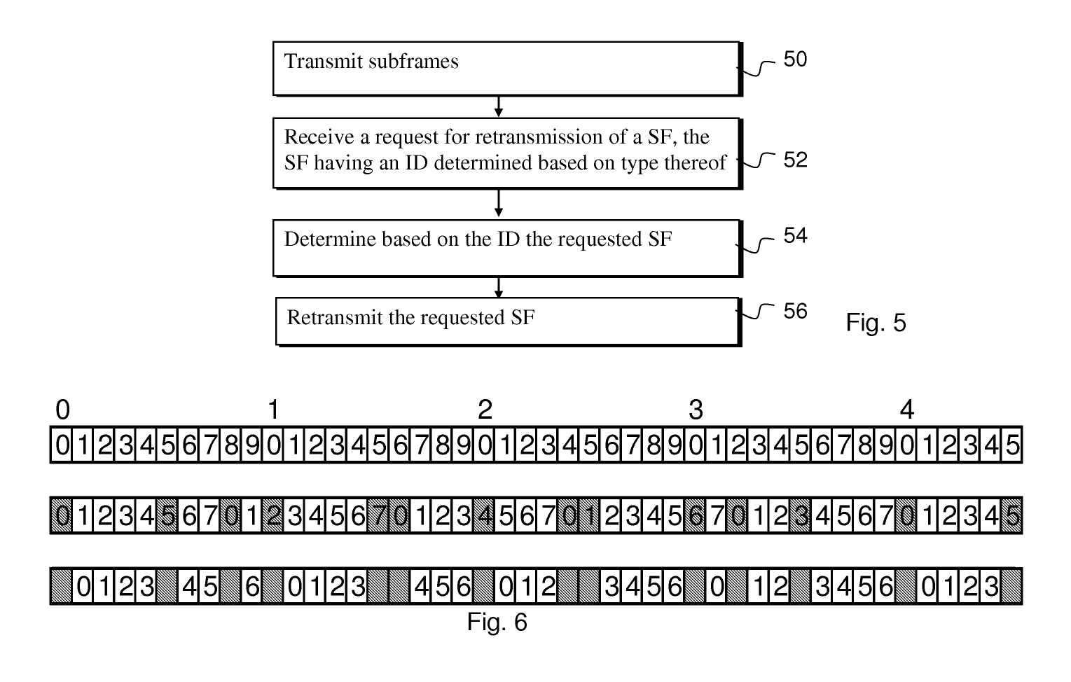

FIGS. 4 and 5 show flow charts according to certain embodiments; and

FIG. 6 is a schematic illustration of an embodiment for identifying subframes for retransmission.

In the following certain exemplifying embodiments are explained with reference to a wireless or mobile communication system serving mobile communication devices. Before explaining in detail the exemplifying embodiments, certain general principles of a wireless communication system and mobile communication devices are briefly explained with reference to FIGS. 1 to 3 to assist in understanding the technology underlying the described examples.

In a wireless communication system mobile communication devices or user equipments (UE) 102, 103 are provided wireless access via at least one base station or similar wireless transmitting and/or receiving node or point. In the FIG. 1 example two overlapping access systems or radio service areas of a cellular system 100 and 110 and two smaller radio service areas 115, 117 provided by base stations 106, 107, 118 and 120 are shown. Each mobile communication device and station may have one or more radio channels open at the same time and may send signals to and/or receive signals from more than one source. It is noted that the radio service area borders or edges are schematically shown for illustration purposes only in FIG. 1. It shall also be understood that the sizes and shapes of radio service areas may vary considerably from the shapes of FIG. 1. A base station site can provide one or more cells. A base station can also provide a plurality of sectors, for example three radio sectors, each sector providing a cell or a subarea of a cell. All sectors within a cell can be served by the same base station.

Base stations are typically controlled by at least one appropriate controller apparatus so as to enable operation thereof and management of mobile communication devices in communication with the base stations. In FIG. 1 control apparatus 108 and 109 is shown to control the respective macro level base stations 106 and 107. The control apparatus of a base station can be interconnected with other control entities. The control apparatus is typically provided with memory capacity and at least one data processor. The control apparatus and functions may be distributed between a plurality of control units.

In FIG. 1 stations 106 and 107 are shown as connected to a wider communications network 113 via gateway 112. A further gateway function may be provided to connect to another network. The smaller stations 118 and 120 can also be connected to the network 113, for example by a separate gateway function and/or via the controllers of the macro level stations. In the example, station 118 is connected via a gateway 111 whilst station 120 connects via the controller apparatus 108.

A non-limiting example of the recent developments in communication system architectures is the long-term evolution (LTE) of the Universal Mobile Telecommunications System (UMTS) that is being standardized by the 3rd Generation Partnership Project (3GPP). As explained above, further development of the LTE is referred to as LTE-Advanced. Non-limiting examples of appropriate LTE access nodes are a macro base station, for example what is known as NodeB (NB) in the vocabulary of the 3GPP specifications, Home eNBs (HeNB), pico eNodeBs (pico-eNB), femto nodes, and radio remote heads (RRH) connected to an eNB The LTE employs a mobile architecture known as the Evolved Universal Terrestrial Radio Access Network (E-UTRAN). Base stations of such systems are known as evolved or enhanced Node Bs (eNBs) and may provide E-UTRAN features such as user plane Radio Link Control/Medium Access Control/Physical layer protocol (RLC/MAC/PHY) and control plane Radio Resource Control (RRC) protocol terminations towards the user devices. Other examples of radio access system include those provided by base stations of systems that are based on technologies such as wireless local area network (WLAN) and/or WiMax (Worldwide Interoperability for Microwave Access).

A possible mobile communication device for transmitting and retransmitting information blocks towards the stations of the system will now be described in more detail in reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples include a mobile station (MS) such as a mobile phone or what is known as a ‘smart phone’, a portable computer provided with a wireless interface card or other wireless interface facility, personal data assistant (PDA) provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. User may also be provided broadcast or multicast data. Non-limiting examples of the content include downloads, television and radio programs, videos, advertisements, various alerts and other information. The mobile device may receive signals over an air interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is also typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The control apparatus of a user equipment can be configured to handle the HARQ processing according to the herein described principles when the network (e.g. eNB) is using muting of some subframes, for example for the purpose of reduced interference in the network. The HARQ process IDs can comprise number of processes and numbering of the processes. The process IDs can be managed using subframe level timing. Because the identities are assigned based on the determined type of the subframes, UL HARQ identities can be assigned adaptively.

The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

FIG. 3 shows an example of a control apparatus for a communication system, for example to be coupled to and/or for controlling a station of an access system. In some embodiments base stations comprise a separate control apparatus. In other embodiments the control apparatus can be another network element. The control apparatus 300 can be arranged to provide control on communications in the service area of the system. The control apparatus 300 can be configured to provide control functions in association with retransmission and muting by means of the data processing facility in accordance with certain embodiments described below. For this purpose the control apparatus comprises at least one memory 301, at least one data processing unit 302, 303 and an input/output interface 304. Via the interface the control apparatus can be coupled to a receiver and a transmitter of the base station. The control apparatus can be configured to execute an appropriate software code to provide the control functions. It shall be appreciated that similar component can be provided in a control apparatus provided elsewhere in the system for controlling reception of sufficient information for decoding of received information blocks.

Communication devices can access the communication system based on various access techniques, such as code division multiple access (CDMA), or wideband CDMA (WCDMA). Other examples include time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

A wireless device can be provided with a Multiple Input/Multiple Output (MIMO) antenna system. MIMO arrangements as such are known. MIMO systems use multiple antennas at the transmitter and receiver along with advanced digital signal processing to improve link quality and capacity. Although not shown in FIGS. 1 and 2, multiple antennas can be provided at the relevant nodes, for example at base stations and mobile stations, and the transceiver apparatus 206 of FIG. 2 can provide a plurality of antenna ports. More data can be received and/or sent where there are more antennae elements.

FIG. 4 shows a flowchart for a method for controlling retransmissions of subframes. In accordance with a possibility the method can be applied for time domain enhanced inter cell interference coordination (TDM eICIC) in an environment such the LTE, and more particularly, to communications between eNBs and user equipments. In accordance with the method, a receiving node receives at 40 on uplink from a transmitting node frames comprising subframes. In the embodiment of FIG. 4 information for use in determining subframe types is provided to the transmitting node at 42. The transmitting node can be provided explicit information about the subframes types and/or information about serving cell ABS patterns or other information wherefrom the types can be determined. At 44 the transmitting node determines the type of each subframe. Retransmission process identifications, typically numbers, are assigned for the subframes to keep synchronization. Control on assignment of identifications for the subframes for the purposes of retransmissions can be provided at 46 based on the determined types of the subframes. The identification procedure can comprise numbering of the subframes for retransmissions such that subframes of at least a type of subframes are ignored.

FIG. 5 shows a flow chart for operation at a transmitting node responding retransmission requests. Subframes (SF) are transmitted at 50 from the transmitting node. In the first transmission each subframe is provided with an identification, for example based on frame and subframe numbers. Subsequently a request for retransmission of at least one subframe is received at 52. The requested subframe is provided by the requesting node with an identification for retransmission purposes based on the type of the subframe the requesting node has determined. The identification for retransmission purposes is different from the identification used when the subframe was previously transmitted, as subframes of at least a type have been ignored and are thus not counted. The transmitting node can then determine at 54 based on the received identification for retransmission purposes which one of the originally transmitted subframes is requested. The requested subframe can then be transmitted at 56.

In accordance with a preferred embodiment the retransmission procedure is applied on the uplink, meaning that an user equipment (UE) is receives and responds to retransmission requests and an eNB or another base station apparatus requests/instructs the UE to provide the retransmissions.

In heterogeneous network (Hetnet) scenarios with TDM ICIC scheme, UL hybrid automatic repeat request (HARQ) process may be impacted/delayed due to muting, for example eNB ABS patterns. In accordance with a more particular embodiment, a user equipment only counts non-ABS as HARQ eligible uplink (UL) subframes. UL HARQ processes can be compressed to match HARQ periodicity. Thus a user equipment mode of operation can be provided where UL HARQ process structure is rearranged to accommodate for efficient HARQ when time domain eICIC ABS causes missing downlink (DL) control channels.

In accordance with an embodiment a user equipment operational mode is provided which allows for time-domain compression of the uplink (UL) HARQ processes. The compression is provided such that the user equipment is made aware of the muting pattern used by the eNB where after the user equipment can ignore any muted UL subframes and only count UL subframes that are identified as non-muted subframes. Instead of the muting pattern, other information based on which muted subframes can be determined may be provided for the user equipment. The total number of user equipment UL HARQ processes can be reduced to match the requirements of a minimum of 8 ms RTT for processing. With this approach, it is possible to maintain the UL synchronous approach while reducing the average potential HARQ latency.

In accordance with an embodiment an UE is configured to be able to distinguish between an almost blank subframe (ABS) and non-ABS in the time domain. To enable this the UE can be informed of the used ABS pattern in the serving cell. An additional benefit that may be obtained from this is that as the UE knows which subframes are ABS, it can ignore the physical downlink control channel (PDCCH), or at least the UE specific search space thereof, and only monitor for paging information and system information block (SIB) transmissions.

The UE may also be informed of the number of HARQ processes that it is expected to use. The UE may also be informed of the subframe that it is supposed to use as a starting point for counting of subframes for retransmission purposes. For example, an UE can be instructed to start at subframe 0 of radio frame 0 so that a well-defined synchronization time can be had between the e-Node B and the UE. According to a possibility the UE may derive the required information from the signaled muting pattern and autonomously define the time synchronization point or subframe for the start of counting at a given reference point. With the information on the muting pattern, the UE can do an internal re-counting of the HARQ process identities (IDs) where the subframes impacted by the ABS are not counted when assigning HARQ process IDs to different subframes.

Explicit signaling can be introduced for enabling the user equipment to determine which subframes are ABS and which are not and/or for other relevant information in this context. The signaling may directly inform the UE of which subframes are ABS, and which are not. The signaling may be based, for example, on radio resource control (RRC) or medium access control (MAC) signaling.

According to a possibility an UE can be configured to couple channel state information (CSI) measurement patterns with the ABS patterns. When TDM eICIC was introduced into the LTE specifications a double set of CSI measurement patterns was also introduced. The e-Node B can have flexibility in defining the measurement instants for these two patterns. However, from interference management point of view the scheduling entity in the e-Node B would mainly be interested in measurements that indicate one of the two conditions. The first condition is that “Measurement is for a situation where interference from neighbors is guaranteed to be interference-free from a data point of view”. This condition can be denoted as “guaranteed ABS”. Correspondingly, the scheduling unit can have information on condition “Measurement is for a situation where there will be no special actions from interfering nodes to reduce interference”. This condition can be denoted as “guaranteed non-ABS”. When interference management is provided between macro and pico layers, there can be a set of resources that are “guaranteed ABS”, and a set of resources that can be “guaranteed non-ABS”. Subframes that are not marked by any pattern can semi-dynamically be categorized in one of the two states, ABS and non-ABS. From a measurement point of view, these remaining subframes with non-deterministic state are not useful when considering scheduling. As for the macro-pico case, there will be a set of subframes that the macro e-Node B will not configure as ABS, and there will be a set of subframes that the macro e-Node B will configure as ABS. This latter part of the set can be useful in certain applications for applying renumbering schemes of HARQ processes at the UE.

An example of an approach where only the non-muted subframes are used for the UL HARQ process numbering is shown in FIG. 6. The top line shows the frame number (0-4) and below them four full sets of subframes 0 to 9 and a part of the subframes of the fifth frame. The middle row shows the muting pattern. For this illustration a so-called 30% muting pattern is used. That is, the macro cell is using muting of 30% of the macro subframes to allow for a pico node range extension. The bottom row shows the allocated HARQ retransmission process numbering. With blind renumbering, it would be possible to squeeze the numbering down such that only six processes are used. However, that may in certain situations conflict with the requirement of the LTE that the HARQ RTT should be at least eight TTIs. Hence, a total of seven HARQ processes are used in the shown LTE related example. As shown, instead of sequentially numbering each subframe of each frame, the HARQ process numbering (0-6) is only allocated to non-muted subframes.

For the proposed HARQ numbering scheme to work, rules can be defined for extracting the number of HARQ processes to use according to muting pattern. A HARQ process starting point can also be defined such that both ends of the communication link, e.g. eNB and UE, have a common understanding of where a process, for example “0”, starts. In accordance with a possibility the first process, e.g. “0”, is transmitted on the PUSCH that is schedulable by the first non-muted PDCCH in frame number 0. This can be the same subframe where for instance TDM eICIC patterns for TDD mode is also reset.

An example of a possible numbering scheme for a HARQ process number 3 shown in FIG. 6 is now explained to illustrate this. As shown, the processes can have different time differences depending on the absolute time. The first instance of process number 3 happens in subframe 4 and second instance happens in subframe 14, as the time difference between first and second instance is ten subframes. The third instance of process number 3 happens at subframe 26, meaning that there is a time difference of twelve subframes. This can be addressed by assigning “0” for the first non-muted subframe of each frame to provide a common understanding of when to start counting of the processes.

With a further reference to FIG. 6, a “normal” HARQ scheme will have an implicit numbering of the processes, meaning that a failed transmission in subframe “0” will cause the retransmission to happen in subframe “8” of the top row, as the retransmission processing delay is 8 ms/8 subframes. In accordance with the embodiments, the communicating nodes, e.g. UE and eNB, are able to map the numbers assigned for retransmission purposes to the originally transmitted subframes and work out when the corresponding retransmission is to happen, and are thus able to handle the retransmission request at the corresponding time. To exemplify this with reference to FIG. 6, the UE can transmit a packet in process “0”, see the bottom row, which corresponds to subframe number “1” in the top row. Now, in case this transmission/reception fails at the eNB, the eNB will have to inform the UE to transmit in subframe number 11 as this is the next available subframe for HARQ process “0”. To ensure this to happen at the right timing the eNB can send the retransmission request in subframe number “7” of the top row. This subframe can be selected to address the delay from the eNB instructing for a retransmission to the actual retransmission, typically at least four subframes. Thus the timing between original transmission, retransmission request and actual retransmission can be fixed according to an agreed numbering scheme for the HARQ processes, for example as shown in FIG. 6.

The required data processing apparatus and functions of a control apparatus for the determinations and control of adaptive handling of retransmission subframes at a communication device, a base station and any other node or element may be provided by means of one or more data processors. The described functions may be provided by separate processors or by an integrated processor. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non limiting examples. The data processing may be distributed across several data processing modules. A data processor may be provided by means of, for example, at least one chip. Appropriate memory capacity can also be provided in the relevant devices. The memory or memories may be of any type suitable to the local technical environment and may be implemented using any suitable data storage technology, such as semiconductor based memory devices, magnetic memory devices and systems, optical memory devices and systems, fixed memory and removable memory.

An appropriately adapted computer program code product or products may be used for implementing the embodiments, when loaded or otherwise provided on an appropriate data processing apparatus, for example for causing determinations for adaptive assignment of retransmission subframe identities and for the related operations. The program code product for providing the operation may be stored on, provided and embodied by means of an appropriate carrier medium. An appropriate computer program can be embodied on a computer readable record medium. A possibility is to download the program code product via a data network. In general, the various embodiments may be implemented in hardware or special purpose circuits, software, logic or any combination thereof. Embodiments of the inventions may thus be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The embodiments may allow application where a reduced number of HARQ processes can be used. This can result a decrease in UL HARQ delay and/or an increase in UL capacity. A more efficient reception of DL subframes when muting of subframes (ABS) are taken into account may also be obtained in certain embodiments. An eNB may configure muting patterns in a more flexible manner. UE battery life may be improved and/or allow use of interference reduction techniques in the network.

It is noted that whilst embodiments have been described in relation to LTE-Advanced, similar principles can be applied to any other communication system where a carrier comprising a multiple of component carriers is employed. Therefore, although certain embodiments were described above by way of example with reference to certain exemplifying architectures for wireless networks, technologies and standards, embodiments may be applied to any other suitable forms of communication systems than those illustrated and described herein.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. For example, a combination of one or more of any of the other embodiments previously discussed can be provided. All such and similar modifications of the teachings of this invention will still fall within the scope of this invention as defined in the appended claims.

1. A method of controlling retransmission of subframes, comprising:
determining the type of a subframe, and
controlling identification of the subframe for retransmission purposes based on the determined type of the subframe.

2. A method of controlling retransmission of subframes, comprising:
receiving a request for retransmission of a subframe, wherein the requested subframe is provided with an identification for retransmission purposes by a receiving station based on the type of the subframe, the identification for retransmission purposes being different from the identification used when previously transmitting the subframe, and
determining based on the identification for retransmission purposes which one of the previously transmitted subframes is requested.

3. A method according to claim 1, wherein the identification comprises numbering of the subframes for retransmissions such that subframes of at least a type are ignored.

4. A method according to claim 1, comprising determining whether the subframe is a muted subframe.

5. A method according to claim 4, wherein the determining of the type comprises determining whether the subframe is an almost blank subframe.

6. A method according to claim 1, comprising sequentially numbering the subframes for retransmissions such that muted subframes are ignored and retransmission identifiers are assigned only for non-muted subframes.

7. A method according to claim 6, comprising assigning sequential HARQ process identities only for non-muted subframes.

8. A method according to claim 1, comprising communicating information of muting of subframes to a user equipment.

9. A method according to claim 1, comprising communicating information about an almost blank subframe pattern of a cell to a user equipment in the cell.

10. A method according to claim 1, comprising determining muted subframes based on channel state information measurement pattern and almost blank subframe pattern.

11. A method according to claim 1, comprising determining the number of retransmission processes.

12. A method according to claim 1, wherein the number of retransmission processes is less than the number of available total of retransmission processes.

13. A method according to claim 1, comprising applying muting patterns to communications for the purposes of time domain enhanced inter-cell interference coordination.

14. An apparatus for controlling retransmissions, the apparatus comprising at least one processor, and at least one memory including computer program code, wherein the at least one memory and the computer program code are configured, with the at least one processor, to
determine the type of a subframe, and
control identification of the subframe for retransmission purposes based on the determined type of the subframe.

15. An apparatus for controlling retransmission of subframes from a transmitting node, the apparatus comprising at least one processor, and at least one memory including computer program code, wherein the at least one memory and the computer program code are configured, with the at least one processor, to process a request for retransmission of a subframe to determine the subframe that is requested based on an identification for retransmission purposes, wherein the identification for retransmission purposes is provided by a receiving node based on the type of the subframe and is different from an identification used when the subframe was previously transmitted by the transmitting node.

16. An apparatus according to claim 14, wherein the identification for retransmission purposes is provided such that subframes of at least a type are ignored.

17. An apparatus according to claim 14, wherein the apparatus is configured to ignore muted subframes and to use retransmission identifiers only for non-muted subframes.

18. An apparatus according to claim 17, wherein the muted subframe comprises an almost blank subframe.

19. An apparatus according to claim 14, configured to use sequential HARQ process identities only for non-muted subframes.

20. An apparatus according to claim 14, configured to determine muted subframes based on channel state information measurement pattern and/or almost blank subframe pattern.

21. An apparatus according to claim 14, configured to use the number of retransmission processes in identifying subframes for retransmission purposes.

22. An apparatus according to claim 14, wherein the number of retransmission processes is less than the number of available total of retransmission processes.

23. An apparatus according to claim 14, configured to control retransmissions between a macro or femto node and a mobile user equipment.

24. A node for a communication system comprising the apparatus as claimed in claim 14.

25. A communication system comprising an apparatus according to claim 14.

26. A computer program comprising code means adapted to perform the steps of claim 1 when the program is run on a processor.
